(19) United States
(12) Patent Application Publication
(10) Pub. No.: US 2006/0161576 A1
(43) Pub. Date: Jul. 20, 2006

(54) Method and apparatus for dimensional data versioning and recovery management

(76) Inventors: John William Barrs, Austin, TX (US); Michael Wayne Brown, Georgetown, TX (US); Paul Stuart Williamson, Round Rock, TX (US)

Correspondence Address: IBM CORP (YA);C/O YEE & ASSOCIATES PC, P.O. BOX 802333, DALLAS, TX, 75380, US

(21) Appl. No.: 11/037,127

(22) Filed: Jan. 18, 2005

(51) Int. Cl. G06F 17/00

(52) U.S. Cl. 707/102

(57) ABSTRACT

A method, apparatus, and computer instructions for managing data. Responsive to a request for a data element from an application in the virtual machine, the data element is allocated to the application. The data element having a number of dimensions for storing application data for the application. A data structure is created to store versioning data for the data element in response to the data structure including an extra dimension to identify the versioning data. Application data is stored from the data element in response to an event. All application data is restored to a requested state using the data structure in response to a user request from a user interface to restore the data in the virtual machine to a prior state.

### CROSS REFERENCE TO RELATED APPLICATIONS

The present invention is related to the following patent applications: entitled “Method and Apparatus for Data Versioning and Recovery Using Delta Content Save and Restore Management”, Ser. No. ______, attorney docket no. AUS920040638US1; entitled “Platform Infrastructure to Provide an Operating System Based Application Programming Interface Undo Service”, Ser. No. ______, attorney docket no. AUS920040639US1; entitled “Virtual Memory Management Infrastructure for Monitoring Deltas and Supporting Undo Versioning in a Paged Memory System”, Ser. No. ______, attorney docket no. AUS920040640US1; entitled “Infrastructure for Device Driver to Monitor and Trigger Versioning for Resources”, Ser. No. ______, attorney docket no. AUS920040641US1; entitled “Method and Apparatus for Managing Versioning Data in a Network Data Processing System”, serial no. AUS920040642US1, attorney docket no. ______; entitled “Heap Manager and Application Programming Interface Support for Managing Versions of Objects”, Ser. No. ______, attorney docket no. AUS920040643US1; entitled “Method and Apparatus for Marking Code for Data Versioning”, Ser. No. ______, attorney docket no. AUS920040644US1; and entitled “Object Based Access Application Programming Interface for Data Versioning”, Ser. No. ______, attorney docket no. AUS920040645US1 filed even date hereof, assigned to the same assignee, and incorporated herein by reference.

### BACKGROUND OF THE INVENTION

1. Technical Field

The present invention relates to an improved data processing system and in particular to a method and apparatus for processing data. Still more particularly, the present invention relates to a method, apparatus, and computer instructions for an automated, incremental versioning, backup and restore mechanism for data elements within a computer system.

2. Description of Related Art

Data storage components, variables, collections, and multi-dimensional collections are used throughout all computer applications. During the execution of an application, the contents of these types of data storage elements will change or evolve. These changes occur due to modifications or updates to the data. These changes may be made by user input or through programmatic means. As the program logic of an application progresses, situations often arise in which the program state and the content of the data storage elements need to be reset to a prior state. This state may be an arbitrary state selected by the user or programmatically by an application. Mechanisms for incrementally saving and resetting data to a prior known state are present in many applications.

Currently available mechanisms are found in applications, such as word processors, for resetting or rolling back to a previous state. A word processor may allow a user to undo changes to a document, such as deletions, insertions, or formatting changes.

A significant problem with existing mechanisms is that they are prone to inefficiencies and require explicit management by the application programmer or end user. Therefore, it would be advantageous to have an improved method, apparatus, and computer instructions for data versioning and recovery management.

### SUMMARY OF THE INVENTION

The present invention provides a method, apparatus, and computer instructions for managing data. An application requests a data element from the memory management subsystem (MMS). The MMS allocates space for the data element and returns a reference (memory address) to the requesting application. The requested data element has a number of dimensions that represent data elements accessible by the application for storing application data. When the MMS allocates the requested space, it also creates an extra dimension on each data element, only accessible by the MMS that it uses to maintain versioning data. The MMS stores application data into the data element in response to a configurable event. All application data is restored to a requested state using the data structure in response to a user request from a user interface to restore the data to a prior state.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in which the present invention may be implemented;

FIG. 3 is a diagram illustrating components used in data versioning and recovery management in accordance with a preferred embodiment of the present invention;

FIG. 4 is a diagram illustrating the modifications of a data element in accordance with a preferred embodiment of the present invention;

FIG. 5 is a diagram illustrating a three-dimensional table stored in memory with the contents of cells from a spreadsheet in accordance with a preferred embodiment of the present invention;

FIG. 6 is a flowchart of a process for providing data versioning in accordance with a preferred embodiment of the present invention; and

FIG. 7 is a diagram illustrating a process for returning data to a previous version in accordance with a preferred embodiment of the present invention.

### DETAILED DESCRIPTION OF THE PREFERRED EMBODIMENT

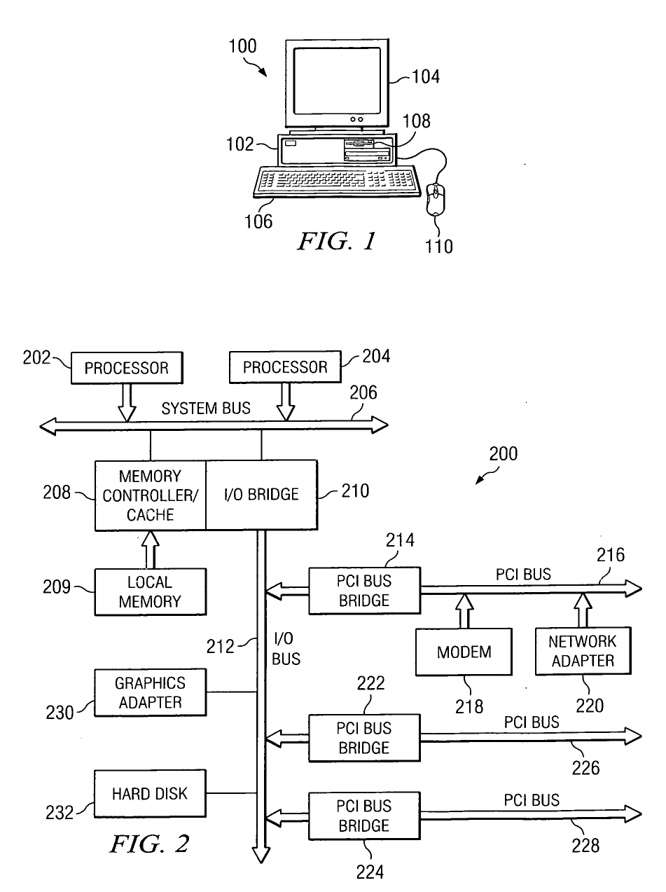

With reference now to the figures and in particular with reference to FIG. 1, a pictorial representation of a data processing system in which the present invention may be implemented is depicted in accordance with a preferred embodiment of the present invention. Computer 100 is depicted which includes system unit 102, video display terminal 104, keyboard 106, storage device 108, which may include floppy drives and other types of permanent and removable storage media, and mouse 110. Additional input devices may be included with personal computer 100, such as, for example, a joystick, touch pad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

Referring to FIG. 2, a block diagram of a data processing system in which the present invention may be implemented. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bridge 210 is connected to system bus 206 and provides an interface to I/O bus 212. Memory controller/cache 208 and I/O bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to other data processing systems may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware in FIG. 2 may vary. For example, other peripheral devices, such as optical disk drives and the like, also may be used in addition to or in place of the hardware depicted. The depicted example is not meant to imply architectural limitations with respect to the present invention.

The present invention provides an improved method, apparatus, and computer instructions for data versioning and recovery management. The mechanism of the present invention can be implemented in various ways. For example, the mechanism of the present invention may be implemented within an operating system or a virtual machine.

In these illustrative examples, a virtual machine is a self-contained operating environment that behaves as if it were a separate computer from other operating environments on a particular data processing system. For example, applets, such as Java applets run on a Java virtual machine, which has no access to the host operating system in the data processing system. In these illustrative examples, a virtual machine has no contact with the operating system providing for insulation from the operating system and reduces the possibility of applications running on a virtual machine from damaging other files or applications belonging to the operating system or other virtual machines. A Java virtual machine in these examples is the software that converts the Java intermediate language, bytecodes, into machine language and executes those machine language instructions. A Java virtual machine is a Java interpreter in these examples. A Java virtual machine may be incorporated into a web browser to execute the Java applets. Additionally, a Java virtual machine also may be installed on a web server to execute server side Java programs. A Java virtual machine also may be installed on the client to run stand-alone Java applications.

In these illustrative examples, one or more applications may be associated with a Java virtual machine. When data versioning occurs, the data versioning occurs for all data associated with a particular Java virtual machine. Thus, if versioning and recovery management is desired for individual applications, each application is associated with a separate Java virtual machine in these illustrative examples.

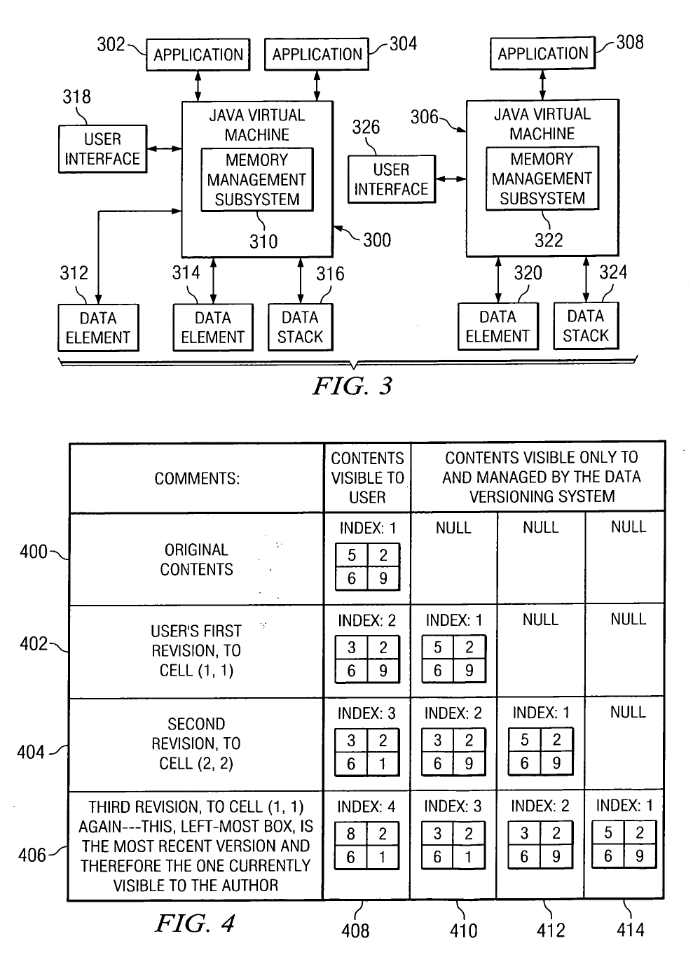

With reference now to FIG. 3, a diagram illustrating components used in data versioning and recovery management are depicted in accordance with a preferred embodiment of the present invention. In this example, Java virtual machine 300 is associated with applications 302 and 304. Java virtual machine 306 is associated with application 308. When a data storage element is requested by application 302, memory management subsystem 310 creates data element 312. When application 304 requests a data element, data element 314 is created by memory management subsystem 310. These data elements may be, for example, a spreadsheet table or a text document.

In addition to creating the data elements as requested by the application, an additional dimension is added to data elements 312 and 314. This additional dimension is visible only to memory management subsystem 310 in these examples. The user does not see the data in the application. Only memory management subsystem 310 accesses or manages this additional dimension. In this example, data stack 316 is associated with data element 312 and data element 314. Data stack 316 contains a snapshot of all of the memory handled by memory subsystem 310 in Java virtual machine 300. An index into the data stack identifies a snapshot of the memory. The index may be based on different criteria. For example, in one illustrative embodiment, the index may take the form of time stamps. In another example, the index may be numerical or even based on a user event.

By indexing through the added dimension, memory management subsystem 310 is able to restore data elements 312 and 314 to a prior version from data stack 316. In these illustrative examples, the user restores all of the memory for Java virtual machine 300 to any prior indexed state stored in data stack 316. As a result, both data elements are restored to the same point when a restoration of data occurs.

Data stack 316 may be located in a number of different locations depending on the implementation. For example, this data stack may be located on a hard disc locally on the data processing system on which the Java virtual machine is located or on a remote storage device on a network connected to the data processing system. In this manner, a user is afforded the ability to restore data elements associated with an application, such as application 302 and application 304 associated with data elements 312 and 314 to any prior data state. In these examples, this change of versioning may occur through user input to user interface 318.

For example, memory management subsystem 310 may restore data element 312 to a prior state using the data stored within the data stack 316. An index, such as a time stamp or other numerical value may be used to identify the version of data within data stack 316 that is to be used to replace the data in data element 312. Other parameters and even functions may be used as an index within data stack 316. In this manner, the individual data elements may be restored to prior states using memory management subsystem 310.

Applications 302 and 304 do not need to provide any functionality or support for the data versioning and recovery management in these illustrative examples. As a result, a user may restore all of the data elements, such as data element 312 and data element 314, for Java virtual machine 300 to the prior state through the user interface 318.

In these examples, data for application 308 is stored in data element 320. This data may be independently stored with respect to the data in data elements 312 and 314. Each time application 308 stores or alters data in data element 320, memory management subsystem 322 stores a snapshot of all the memory managed by memory management subsystem 322 in data stack 324. Data element 320 may be restored to a prior state through user input to user interface 326. Memory management subsystem 322, manages all of the memory accessed by Java applications.

This restoring of data occurs for all of the memory managed by memory management subsystem 322. In this manner, different applications may be restored to different states through associating the applications with different Java virtual machines. Depending upon the particular implementation, the mechanism of the present invention also may be implemented with any host operating system instead of or in addition to virtual machines.

Turning now to FIG. 4, a diagram illustrating the modifications of a data element is depicted in accordance with a preferred embodiment of the present invention. In this illustrative example, the data element is a spreadsheet requested by an application. When an application requests a two-dimensional table, the memory management subsystem of the present invention creates a three-dimensional array, but exposes only two-dimensions to the user through the application. The third dimension along with data from data element 312 may be stored in a data structure, such as data stack 316 in FIG. 3. This third dimension is an index used to identify the version of the data. Entries 400, 402, 404, and 406 illustrate the user modifications to a spreadsheet.

Although specific changes are shown in FIG. 4, all of the memory managed by a memory management subsystem is stored in a data structure, such as data stack in 316 in FIG. 3. Each element in the third dimension of the array is actually a snapshot of the memory at the time the entry is made. Only the contents of the spreadsheet are shown to illustrate the mechanism of the present invention.

The contents visible to the user and the spreadsheet are shown in column 408 and the contents that are visible only to the mechanism of the present invention are shown in columns 410, 412 and 414. Entry 400 shows the original content of the spreadsheet in column 408. As can be seen, the spreadsheet contains four cells. Index 1 in this entry is the information stored in a data stack, such as data stack 316 in FIG. 3. No data is present for data versioning in entry 400.

Next, in entry 402 a first revision is made to the cell in position (1, 1) as can be seen in column 408. The number 5 has changed to a number 3. This new data is provided with a second index as can be seen in column 408. The first index data is now managed by the data versioning system as can be seen in column 410 of entry 402.

Next, a second revision is made to the spreadsheet in cell (2, 2). As can be seen in column 408 for entry 404, the value 9 has changed to a 1. This revision is given a third index number. The first two index versions are managed by the data versioning system as can be seen in columns 410 and 412 of entry 404.

A third revision is made to cell (1, 1). In this case, the number 3 is now changed to a number 8. These contents are visible to the user and are assigned a fourth index. The first three index versions are now managed by the data versioning system and they are not seen by the user in columns 410, 412, and 414 of entry 406.

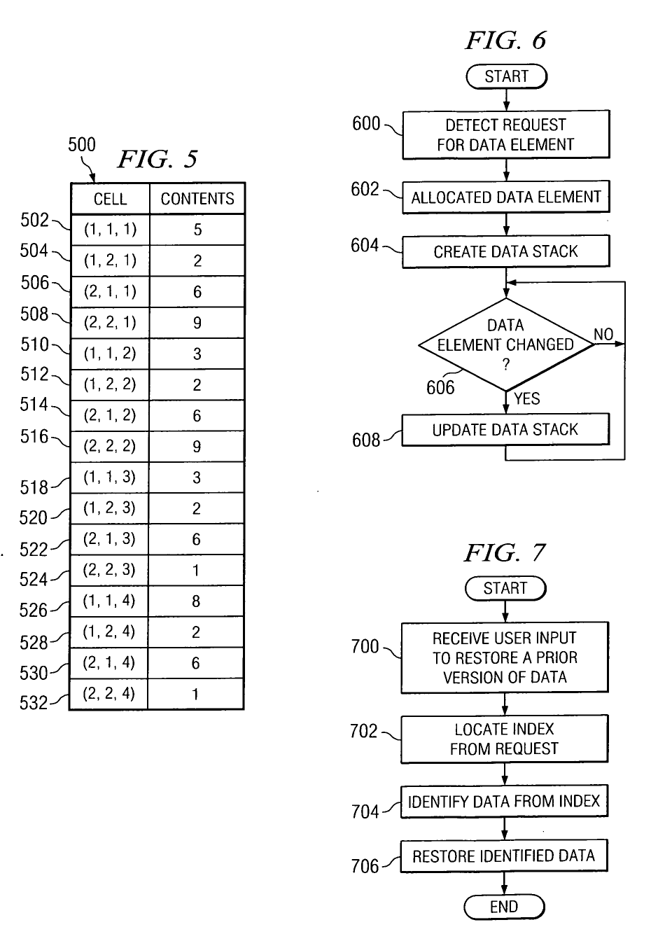

Turning now to FIG. 5, a diagram illustrating a three-dimensional table stored in memory with the contents of cells from a spreadsheet are depicted in accordance with a preferred embodiment of the present invention. This diagram illustrates contents of a data structure containing data reflecting different states of cells in a spreadsheet.

Table 500 is a specific example of data in memory that may be stored in snapshots in a data stack, such as data stack 316 in FIG. 3. Each time a change is made to the spreadsheet, the information for the spreadsheet is stored in table 500.

From table 500, the current information from the table is populated with the contents corresponding to the cells. Entries 502, 504, 506, and 508 show the original contents of the spreadsheet illustrated in FIG. 4. These contents are stored in an initial snapshot in these examples. The cell locations are found in the first two numbers, while a third number in the entries in table 500 represents the index. For example, (1, 1) is an index identifying the top left most cell with the original contents. The contents are 5. Entry 510 shows an index of (1, 1, 2). The first two numbers identify the upper left most cell. The number 2 is another index indicating that a first revision has occurred from the original. This index points to another snapshot of the memory containing the cells in the spreadsheet. The contents of the cell at that point are a number 3. Entries 512, 514, and 516 are the rest of the cells in the spreadsheet after the first revision. Entries 518, 520, 522, and 524 in table 500 identify the contents of the spreadsheet after the second revision. These entries are identified through an index number 3. Entries 526, 528, 530, and 532 identify a third revision the spreadsheet. These entries are the currently visible contents with respect to the example discussed in FIG. 4. The data in the cells are the contents currently in the memory.

In these examples, numerical indexes are used in table 500. These indexes could easily be replaced with timestamps to allow a user to identify a particular time for restoring data to a prior state. To return the contents of the spreadsheet to its original state, the user sends a request to the memory management subsystem with the appropriate index. In this case, the index number is 1. At that time, the memory management subsystem returns the spreadsheet to that original state from the current state. If the user wants the data after the first revision, the user would request a restoration corresponding to number 2.

Additionally, the memory may be updated when the user leaves the data element that has been changed with the added dimension being incremented and populated with the contents of the memory managed by the memory management subsystem at that time. This update to the table in FIG. 5 need not occur when the data element is changed. The update also may also occur, for example, at preset time intervals, when the file is saved, when the application terminates, or other circumstances or events.

Turning now to FIG. 6, a flowchart of a process for providing data versioning is depicted in accordance with the preferred embodiment of a present invention. The process illustrated in FIG. 6 may be implemented in a system, such as memory management subsystem 310 in FIG. 3.

The process begins by detecting a request for a data element (step 600). This request may be received from an application, such as application 302 in FIG. 3. In response to receiving this request, the data elements are allocated to the requesters (step 602). A data stack is then created to store snapshots of the memory managed by the memory management subsystem (step 604). In these examples, the data stack takes the form of a set of snapshots of the memory. Of course, any type of data structure may be used to track the data for the data elements in different states or versions.

Next, a determination is made as to whether the data element has changed (step 606). If the data element has not changed, the process returns back to the step and continues to make this determination until a change occurs. If the data element has changed, the data stack is updated to include the new version of the data (step 608) with the process then returning to step 606. This update involves copying all of the content in the memory managed by the memory management subsystem. In step 608, the changed version of the data is associated with an index allowed for locating prior versions of the data in the data stack. In other words, an index is associated with the contents or snapshot of the memory.

In step 604, in creating the data stack, the current version or contents visible to a user are stored in the data stack in association with an index. This index may take various forms. First, index numbers may be used. Additionally, time stamps also may be used for the index.

Turning now to FIG. 7, a flowchart of a process for returning data to a previous version is depicted in accordance with a preferred embodiment of the present invention. The process illustrated in FIG. 7 may be implemented in a memory management system, such as memory management subsystem 310 in FIG. 3.

The process begins by receiving a user input to restore a prior version of data (step 700). An index is identified from the request (step 702) and this index is used to identify the data (step 704). In these examples, the data is a copy of the content in the memory managed by the memory management subsystem. Other data for other programs may be located in this copy. The identified data is then restored (step 706) with the process terminating thereafter. Step 706 restores the data for all of the data that was present in the memory at the time the content was copied or stored in association with the index.

Thus, the present invention provides an improved method, apparatus, and computer instructions for data versioning and recovery management. The mechanism of the present invention adds an additional dimension for any n-dimensional storage element or array. As a result, the mechanism of the present invention may be applied to any type of data element regardless of the number of dimensions in this element. In storing and indexing the version data, a user input may be received independently of any applications to restore the data to a prior version or state.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although the illustrative embodiments use a Java virtual machine, the mechanism of the present invention may be applied to any virtual machine or operating system to provide the data versioning and data recovery. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a virtual machine in a data processing system for managing data, the method comprising:
responsive to a request for a data element from an application in the virtual machine, allocating the data element to the application, wherein the data element has a number of dimensions for storing application data for the application;
creating a data structure to store versioning data for the data element, wherein the data structure includes an extra dimension to identify the versioning data;
responsive to an event, storing the application data from the data element in the data structure; and
responsive to a user request from a user interface to restore the data in the virtual machine to a prior state, restoring all application data to a requested point using the data structure.

2. The method of claim 1, wherein the storing step includes:
storing the application data in the data structure; and
associating the application data with an index from the extra dimension.

3. The method of claim 1, wherein the restoring step includes:
identifying a subset of the versioning data in the data structure from the user request; and
replacing the application data in the data element with the subset of the versioning data.

4. The method of claim 1, wherein the creating step comprises:
allocating a data stack to store the versioning data, wherein the data stack includes the extra dimension.

5. The method of claim 4, wherein the data stack is a table.

6. The method of claim 3, wherein the identifying step and the replacing step are performed for each data element in the virtual machine.

7. The method of claim 1, wherein the virtual machine is a Java virtual machine.

8. The method of claim 1, wherein the index is one of a numerical index or a timestamp.

9. The method of claim 1, wherein the event is at least one of a periodic event, expiration of a timer, saving of any application data, exiting the application, and deleting application data.

10. A data processing system for managing data in virtual machine, the data processing system comprising:
a bus system;
a communications unit connected to the bus system;
a memory connected to the bus system, wherein the memory includes a set of instructions; and
a processing unit connected to the bus system, wherein the processing unit executes the set of instructions to allocate the data element to the application in response to receiving a request for a data element from an application in the virtual machine in which the data element has a number of dimensions for storing application data for the application, create a data structure to store versioning data for the data element in which the data structure includes an extra dimension to identify the versioning data, store the application data from the data element in the data structure in response to an event; and restore all application data to a requested point using the data structure in response to a user request from a user interface to restore the data in the virtual machine to a prior state.

11. A data processing system in a virtual machine in a data processing system for managing data, the data processing system comprising:
allocating means, responsive to a request for a data element from an application in the virtual machine, for allocating the data element to the application, wherein the data element has a number of dimensions for storing application data for the application;
creating means creating a data structure to store versioning data for the data element, wherein the data structure includes an extra dimension to identify the versioning data;
storing means, responsive to an event, for storing the application data from the data element in the data structure; and
restoring means, responsive to a user request from a user interface to restore the data in the virtual machine to a prior state, for restoring all application data to a requested point using the data structure.

12. The data processing system of claim 11, wherein the storing means includes:
storing means for storing the application data in the data structure; and
associating means for associating the application data with an index from the extra dimension.

13. The data processing system of claim 11, wherein the restoring means includes:
identifying means for identifying a subset of the versioning data in the data structure from the user request; and
replacing means for replacing the application data in the data element with the subset of the versioning data.

14. The data processing system of claim 11, wherein the creating means comprises:
allocating means for allocating a data stack to store the versioning data, wherein the data stack includes the extra dimension.

15. A computer program product in a computer readable medium for managing data, the computer program product comprising:
first instructions for allocating the data element to the application responsive to a request for a data element from an application in the virtual machine, wherein the data element has a number of dimensions for storing application data for the application;
second instructions for creating a data structure to store versioning data for the data element, wherein the data structure includes an extra dimension to identify the versioning data;
third instructions, responsive to an event, for storing the application data from the data element in the data structure; and
fourth instructions, responsive to a user request from a user interface to restore the data in the virtual machine to a prior state, for restoring all application data to a requested point using the data structure.

16. The computer program product of claim 15, wherein the third instructions includes:
first sub instructions for storing the application data in the data structure; and
second sub instructions for associating the application data with an index from the extra dimension.

17. The computer program product of claim 15, wherein the fourth instructions includes:
first sub instructions for identifying a subset of the versioning data in the data structure from the user request; and
second sub instructions for replacing the application data in the data element with the subset of the versioning data.

18. The computer program product of claim 15, wherein the second instructions comprises:
sub instructions for allocating a data stack to store the versioning data, wherein the data stack includes the extra dimension.

19. The computer program product of claim 18, wherein the data stack is a table.

20. The computer program product of claim 17, wherein the first sub instructions and the second sub instructions are performed for each data element in the virtual machine.

21. The computer program product of claim 15, wherein the virtual machine is a Java virtual machine.

22. The computer program product of claim 15, wherein the index is one of a numerical index or timestamp.

23. The computer program product of claim 15, wherein the event is at least one of a periodic event, expiration of a timer, saving of any application data, exiting the application, and deleting application data.
